(19) United States
(12) Patent Application Publication
(10) Pub. No.: US 2002/0090101 A1
(43) Pub. Date: Jul. 11, 2002

(54) Earphone compatible with principle of acoustics

(76) Inventor: Hsi Kuang Ma, Taipei (TW)

Correspondence Address: Dougherty & Troxell, ONE SKYLINE PLACE, SUITE 1404, 5205 LEESBURG PIKE, FALLS CHURCH, VA, 22041, US

(21) Appl. No.: 09/765,327

(22) Filed: Jan. 22, 2001

(30) Foreign Application Priority Data
Jan. 5, 2001 (TW) 90200217

(51) Int. Cl. H04R 25/00

(52) U.S. Cl. 381/322; 381/23.1; 381/328

(57) ABSTRACT

An earphone compatible with principle of acoustics comprises a case, a set of voice emitting components, and a connecting wire. The case provides a plurality of apertures thereon and a wire hole. The voice emitting components are received in the case and at least include a vibratory membrane and a magnet. The vibratory membrane near the wire hole and away the lateral side of the case. The connecting wire at an end thereof is joined to the magnet and at the other end thereof passes through the wire hole and extending outward to connect with an audio device. While the earphone is inserted into the ear, a lateral end of the case faces the acoustic meatus and the vibratory membrane faces the outer opening space. Hence, it is possible to form a desirable resonant space confined by way of the case, the acoustic meatus, and the eardrum.

### BACKGROUND OF THE INVENTION

1. Field of The Invention

The present invention relates to an earphone compatible with the principle of acoustics, and particularly to an earphone, which is arranged in accordance with the principle of sound reproduction for obtaining better tone quality.

2. Description of Related Art

An earphone has been adopted as a voice receiver for years. Especially, the portable audio device such as the portable stereo is popularly used so that the earphone becomes one of essential component for the sound equipment. Therefore, it can be frequently seen that there are a lot of people wearing the earphone regardless being in the car, or the park, or on the street.

In fact, comparing to the portable stereo or other audio device, the earphone is an accessory with regard to the cost and the size. Therefore, most people often neglect the importance of role played by the earphone. A good earphone can provide not only the clear sound signal but also the reproduction of original sound. Of course, the device in the earphone such as the vibratory membrane also one of factors affecting the tone quality.

For the traditional and prior art of earphone, the earphone we have already used, is not compatible with the principle of acoustics. Referring to FIGS. 1 and 2, an earphone worn in the ear is somewhat like a voice box “A”. That is, a resonant box or resonant space “B” is a required part except the loudspeaker because the resonant space “B” can offer resonance. Therefore, the resonant space should be positioned opposite to the vibratory membrane of loudspeaker based on the basic structure of voice box. That is, the vibratory membrane should face the opening space to obtain a better and freer effect of vibration.

However, the earphone we have used at the present infringes this principle because the vibratory membrane faces the acoustic meatus “C”. Thus, the outer side of earphone provides no resonance so that it is almost in a close state between the vibratory membrane and the acoustic meatus “C”. In this way, it is not possible for the vibratory membrane to vibrate freely without any restriction. As a result, it becomes mixed up for the high compass and low compass such that the low tone is produced with undesirable sound signal.

### SUMMARY OF THE INVENTION

An object of the present invention is to provide an earphone compatible with principle of acoustics, with which an excellent sound reproduction can be reached effectively.

### BRIEF DESCRIPTION OF THE DRAWINGS

The present invention can be more fully understood by referring to the following description and accompanying drawings, in which:

FIG. 1 is a plan view illustrating the conventional earphone mounted in the ears;

FIG. 2 is a diagram illustrating the conventional earphone contrasting with voice box;

FIG. 3 is a plan view illustrating an earphone according to the present invention mounted in the ears; and

FIG. 4 is a diagram illustrating the earphone of present invention contrasting with voice box.

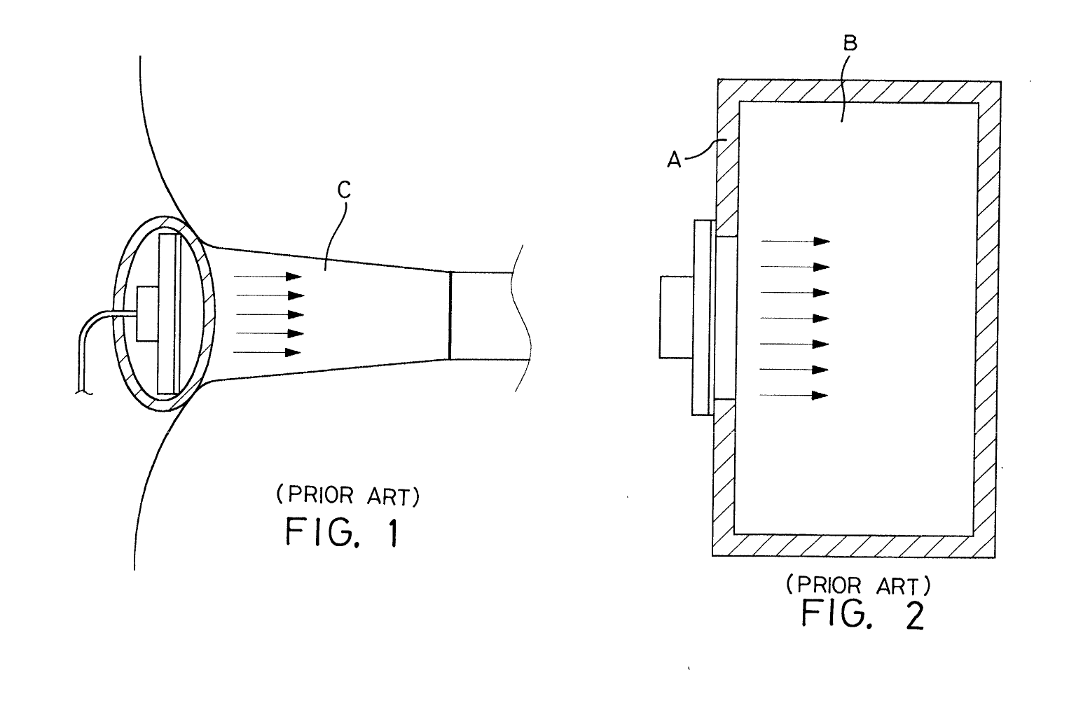

### DETAILED DESCRIPTION OF THE PREFERRED EMBODIMENTS

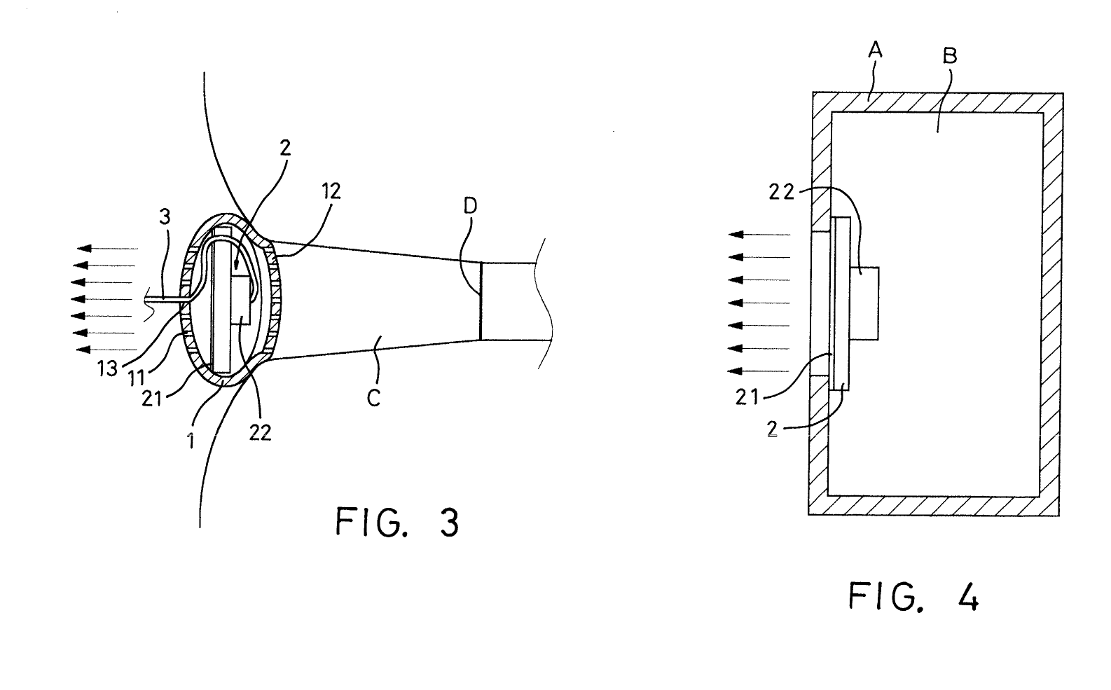

Referring to FIGS. 3 to 4, basically, the earphone of present invention has been positioned in the ears in an opposite orientation to the prior art has been done while a user wears the earphone of the present invention. Accordingly, the earphone of the present invention is designed to differentiate from the prior art and comprises a case 1, a set of voice generating components 2, and a connecting wire 3.

Wherein, the case 1 at least is partly closed and receives the set of voice generating components 2 therein. The case 11 provides a plurality of apertures as outlets of sound transmission. The arrangement of outlets is prior art so that no detail will be described further. In order to be feasible for weaning, the case 1 at a portion thereof near the acoustic meatus “C” may be provided with a projection 12 corresponding to the outer opening of acoustic meatus “C”. Besides, a wire hole 13 is provided on the case 1 next to a vibratory membrane 21 of the voice generating component 2 such that the wire 3 can pass through the wire hole 13 and extends outward.

The voice generating component 2 is a prior art and at least comprises the vibratory membrane 21 and a magnet 22. The magnet 22 joins the connecting wire 3 for signal input.

The connecting wire 3 at an end thereof joins the magnet and the other end thereof passes through the wire hole 13 and extends outward to join an audio device. As shown in FIG. 3, the wire 3 extends outward from the front side of vibratory membrane 21 instead of the rear side thereof. Contrarily, the connecting wire in the prior art extends from the rear side of vibratory membrane.

Referring to FIGS. 3 and 4, the projection 12 is inserted into the ear to face the acoustic meatus “C” and the membrane 21 is positioned opposite the projection 12 to face outside. Hence, the membrane 21 may vibrate freely in case of facing the external opening space. Mean while, a resonant space “B” like a voice box “A” is constituted among the projection 12, the acoustic meatus “C”, and the eardrum “D”. Thus, it is possible to perform an excellent sound output and the reproduced tone quality is better than the prior art does. Especially, the low pitch can be enhanced conspicuously. Therefore, the achievement of present invention overrides the prior art substantially.

While the invention has been described with reference to preferred embodiment thereof, it is to be understood that modifications or variations may be easily made without departing from the spirit of this invention, which is defined by the appended claims.

What is claimed is:

1. An earphone compatible with principle of acoustics, comprising
a case with a lateral end, providing a plurality of apertures thereon and a wire hole;
a set of voice emitting components, being received in the case, at least including a vibratory membrane and a magnet, and the vibratory membrane near the wire hole and away the lateral side of the case; and
a connecting wire with two ends, one of the ends being joined to the magnet, and the other one of the ends passing through the wire hole and extending outward to connect with an audio device;
whereby, while the earphone is inserted into one of the ears, the lateral end of the case faces the acoustic meatus and the vibratory membrane vibrates facing the outer opening space such that a resonant space is confined by the case, the acoustic meatus, and the eardrum.

2. The earphone compatible with principle of acoustics according to claim 1, wherein the case is flat oval shape.

3. The earphone compatible with principle of acoustics according to claim 1, wherein the lateral end of the case may be a projection with a size for fitting with the opening of the acoustic meatus.
